(19) United States
(12) Patent Application Publication
(10) Pub. No.: US 2026/0004333 A1
(43) Pub. Date: Jan. 1, 2026

(54) System and Method for Edge-cloud Collaborative Recommendation, and Electronic Device

(71) Applicant: ALIBABA INNOVATION PRIVATE LIMITED, Singapore (SG)

(72) Inventors: Jiangchao YAO, Hangzhou, Zhejiang (CN); Feng WANG, Hangzhou, Zhejiang (CN); Hongxia YANG, Hangzhou, Zhejiang (CN); Jingren ZHOU, Hangzhou, Zhejiang (CN); Fei WU, Hangzhou, Zhejiang (CN); Kun KUANG, Hangzhou, Zhejiang (CN)

(21) Appl. No.: 18/869,022

(22) PCT Filed: May 22, 2023
(86) PCT No.: PCT/CN2023/095621

§ 371 Date: Nov. 25, 2024

(30) Foreign Application Priority Data
May 23, 2022 (CN) 202210559808.8

(51) Int. Cl. G06Q 30/0601

(52) U.S. Cl. CPC G06Q 30/0631

(57) ABSTRACT

Embodiments of the present disclosure provide a system and method for edge-cloud collaborative recommendation, and an electronic device. The system for edge-cloud collaborative recommendation includes: a terminal device and a cloud server. The cloud server is arranged for: obtaining user feature data of the terminal device; selecting, based on a relative recommendation matching degree between multiple recommendation models and the user feature data, a matched recommendation model from the multiple recommendation models, the multiple recommendation models including an end-side recommendation model deployed in the terminal device and a cloud-side recommendation model deployed in the cloud server, and the relative recommendation matching degree indicating a relative recommendation effect of the multiple recommendation models on the user feature data; and recommending to the terminal device based on the matched recommendation model. According to the solution of the embodiments of the present disclosure, efficient collaboration between the end side recommendation model and the cloud side recommendation model can be implemented, and the recommendation effect can be improved.

The present disclosure claims the priority to Chinese Patent Application No. 202210559808.8, filed with the China National Intellectual Property Administration on May 23, 2022 and entitled “System and method for edge-cloud collaborative recommendation, and electronic device”. Contents of the present disclosure are hereby incorporated by reference in entirety of the Chinese Patent Application.

### TECHNICAL FIELD

Embodiments of the present disclosure relate to the technical field of computers, and in particular to a system and method for edge-cloud collaborative recommendation, and an electronic device.

### BACKGROUND OF THE INVENTION

At present, a variety of recommendation systems are available and different types of recommendation systems each have their strengths and weaknesses. Some recommendation systems give priority over real-time recommendation, thus improving recommendation efficiency, while some recommendation systems give priority over accurate recommendation, thus improving recommendation reliability.

For instance, in a recommendation system of a first type, a cloud server obtains multiple candidate products through recalling and sorting and then presents the multiple candidate products to a user, resulting in a network transmission delay between a recommendation algorithm and a real-time behavior of the user.

For another instance, in a recommendation system of a second type, a cloud-side recommendation system interacts with the user more frequently, leading to higher network resource consumption.

For another instance, in a recommendation system of a third type, a mobile device is allowed to fully participate in an entire algorithm flow of a recommendation system, and this operation is upgraded to an algorithm link of the recommendation system. Through designing an efficient and lightweight algorithm solution on an end device, content recommendation driven by real-time interest of the user can be implemented.

Recommendation models based on different recommendation algorithms are used in the various recommendation systems described above. However, there is still room for improvement in recommendation effect with a single recommendation model.

### SUMMARY OF THE INVENTION

In view of that, embodiments of the present disclosure provide a system and method for edge-cloud collaborative recommendation, and an electronic device, so as to at least partially solve the above problems.

A first aspect of some embodiments of the present disclosure provides a system for edge-cloud collaborative recommendation. The system includes: a terminal device and a cloud server. The cloud server is arranged for: obtaining user feature data of the terminal device; selecting, based on a relative recommendation matching degree between multiple recommendation models and the user feature data, a matched recommendation model from the multiple recommendation models, the multiple recommendation models including an end-side recommendation model deployed in the terminal device and a cloud-side recommendation model deployed in the cloud server, and the relative recommendation matching degree indicating a relative recommendation effect of the multiple recommendation models on the user feature data; and recommending to the terminal device based on the matched recommendation model.

In some embodiments of the present disclosure, the cloud server is further arranged for: inputting the user feature data into a controller to select the matched recommendation model, where the controller is determined according to a model selection data set, and the model selection data set is created based on training data of the multiple recommendation models.

In some embodiments of the present disclosure, the cloud server is further arranged for: inputting the user feature data into the matched recommendation model to obtain a recommendation result.

In some embodiments of the present disclosure, the user feature data includes user real-time feature data and user historical feature data of an application. Accordingly, the cloud server is further arranged for: inputting the user real-time feature data and the user historical feature data into the end-side recommendation model to obtain a real-time recommendation result of the application.

In some embodiments of the present disclosure, the user feature data includes user historical feature data of an application. Accordingly, the cloud server is further arranged for: inputting the user historical feature data into the cloud-side recommendation model to obtain a recommendation result of the application.

A second aspect of the present disclosure provides a method for creating a data set. The method includes that: recommendation condition data is obtained; the recommendation condition data is inputted into multiple pre-trained simulating recommendation models to obtain multiple recommendation results, respectively, the multiple simulating recommendation models being arranged for simulating multiple recommendation models, respectively, and the multiple recommendation models at least including a cloud-side recommendation model and an end-side recommendation model; recommendation effects of the multiple recommendation results on the recommendation condition data are compared to obtain a model selection label; and a model selection data set of the multiple recommendation models is created based on the recommendation condition data and the model selection label.

In some embodiments of the present disclosure, the inputting the recommendation condition data into the multiple pre-trained simulating recommendation models includes that: the recommendation condition data is inputted into a sequence coding layer to obtain a recommendation condition sequence corresponding to the recommendation condition data; and the recommendation condition sequence is inputted into the multiple pre-trained simulating recommendation models.

In some embodiments of the present disclosure, the method further includes that: training data of each recommendation model is obtained, where the training data includes a recommendation condition and a recommendation result; and the multiple simulating recommendation models are trained based on the training data of each recommendation model, respectively.

In some embodiments of the present disclosure, an operation of comparing the recommendation effects of the multiple recommendation results on the recommendation condition data to obtain the model selection label includes that: multiple matching degrees between the multiple recommendation results and the recommendation condition data are determined, the multiple matching degrees indicating the recommendation effects of the multiple recommendation results, respectively; and the model selection label is determined based on the multiple matching degrees, the model selection label indicating a relative recommendation effect between the multiple recommendation results.

In some embodiments of the present disclosure, an operation of comparing the recommendation effects of the multiple recommendation results on the recommendation condition data to obtain a model selection label includes that: respective product popularity of the multiple recommendation results is determined, the product popularity indicating a recommendation effect; and the model selection label is determined based on the respective product popularity of the multiple recommendation results, the model selection label indicating a relative recommendation effect between the multiple recommendation results.

In some embodiments of the present disclosure, the multiple recommendation models include real-time recommendation models and time-share recommendation models.

In some embodiments of the present disclosure, the real-time recommendation models include a cloud-side real-time recommendation model and an end-side real-time recommendation model.

A third aspect of some embodiments of the present disclosure provides a method for training a model. The method includes that: a model selection data set is obtained, the model selection data set being created through the method according to the second aspect; and a controller is trained based on the model selection data set, the controller being arranged for selecting a matched recommendation model from multiple recommendation models.

A fourth aspect of some embodiments of the present disclosure provides a method for edge-cloud collaborative recommendation. The method includes that: user feature data is obtained; and based on a relative recommendation matching degree between multiple recommendation models and the user feature data, a matched recommendation model is selected from the multiple recommendation models, the multiple recommendation models including an end-side recommendation model and a cloud-side recommendation model, the multiple recommendation models include the end-side recommendation model deployed in a terminal device and the cloud-side recommendation model deployed in a cloud server, and the relative recommendation matching degree indicating a relative recommendation effect of the multiple recommendation models on the user feature data.

In some embodiments of the present disclosure, an operation of selecting, based on the user feature data, the matched recommendation model from the multiple recommendation models includes that: the user feature data is inputted into a controller to select the matched recommendation model, the controller being determined according to a model selection data set, and the model selection data set being created based on training data of the multiple recommendation models.

In some embodiments of the present disclosure, an operation of performing recommendation based on the matched recommendation model includes that: the user feature data is inputted into the matched recommendation model to obtain a recommendation result.

In some embodiments of the present disclosure, the user feature data includes user real-time feature data and user historical feature data of an application. An operation of inputting the user feature data into the matched recommendation model to obtain a recommendation result includes that: the user real-time feature data and the user historical feature data are inputted into the end-side recommendation model to obtain a real-time recommendation result of the application.

In some embodiments of the present disclosure, the user feature data includes user historical feature data of an application. An operation of inputting the user feature data into the matched recommendation model to obtain the recommendation result includes that: the user historical feature data is inputted into the cloud-side recommendation model to obtain a recommendation result of the application.

A fifth aspect of some embodiments of the present disclosure provides an electronic device. The electronic device includes: a processor, a memory, a communication interface, and a communication bus. The processor, the memory and the communication interface are in communication with one another by means of the communication bus. The memory is arranged for storing at least one executable instruction. The at least one executable instruction enables the processor to execute an operation corresponding to the method according to any one of the first aspect to the third aspect.

A sixth aspect of some embodiments of the present disclosure provides a computer storage medium, which stores a computer program. When the computer program is executed by a processor, the method according to any one of the first aspect to the third aspect is implemented.

In the solution of the embodiments of the present disclosure, the recommendation model is selected from the multiple recommendation models including the end-side recommendation model and the cloud-side recommendation model, such that collaboration between the end-side recommendation model and the cloud-side recommendation model can be implemented. In addition, the relative recommendation matching degree indicates the relative recommendation effect of the multiple recommendation models on the user feature data. Therefore, the recommendation model is selected based on the relative recommendation matching degree between the multiple recommendation models and the user feature data, and an applicable recommendation model can be reliably selected. That is, in a case where the end-side recommendation model is applicable, recommendation is performed by the end-side recommendation model, and in a case where the cloud-side recommendation model is applicable, recommendation is performed by the cloud-side recommendation model, such that the recommendation effect can be improved.

### BRIEF DESCRIPTION OF DRAWINGS

In order to more clearly illustrate technical solutions in embodiments of the present disclosure or in the related art, the accompanying drawings required for the description of the embodiments or the related art will be briefly introduced below. Obviously, the accompanying drawings in the following description are some embodiments described in the embodiments of the present disclosure, and those of ordinary skill in the art would also be able to derive other drawings from these drawings.

FIG. 1 is a schematic block diagram of a recommendation system according to one instance.

FIG. 2 is a schematic block diagram of a system for edge-cloud collaborative recommendation according to some embodiments of the present disclosure.

FIG. 3 is a flow diagram of a method for edge-cloud collaborative recommendation according to some embodiments of the present disclosure.

FIG. 4 is a schematic block diagram of a system for edge-cloud collaborative recommendation as shown in FIG. 2.

FIG. 5 is a flow diagram of a method for creating a data set according to some embodiments of the present disclosure.

FIG. 6 is a flow diagram of a method for training a model according to some embodiments of the present disclosure.

FIG. 7 is a schematic structural diagram of an electronic device according to some embodiments of the present disclosure.

### DETAILED DESCRIPTION OF THE INVENTION

In order to enable those skilled in the art to better understand technical solutions in embodiments of the present disclosure, the technical solutions of the embodiments of the present disclosure will be described in detail below clearly in conjunction with accompanying drawings of the embodiments of the present disclosure. Obviously, the embodiments described are some embodiments rather than all embodiments of the present disclosure. Based on the embodiments of the present disclosure, all other embodiments obtained by those of ordinary skill in the art should fall within the protection scope of the embodiments of the present disclosure.

Specific implementation of the embodiments of the present disclosure will be further described below in conjunction with the accompanying drawings of the embodiments of the present disclosure.

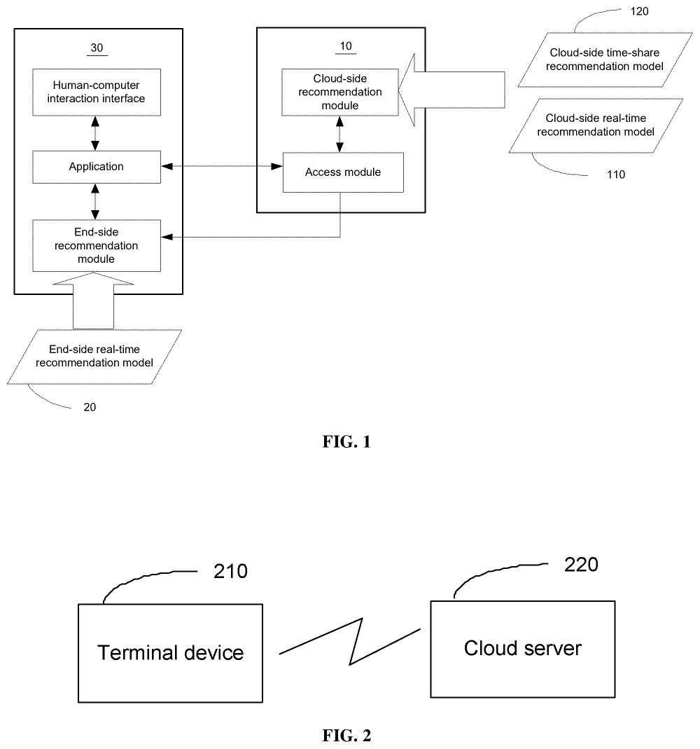

FIG. 1 is a schematic block diagram of a recommendation system according to one instance. The recommendation system as shown in FIG. 1 includes a cloud server 10 and a terminal device 30. Both the terminal device 30 and the cloud server 10 are electronic devices capable of data processing. The terminal device 30 includes, but is not limited to, a mobile terminal such as a mobile phone, a vehicular computer, and a tablet computer, a desktop computer, etc. The cloud server 10 includes, but is not limited to, a cloud server such as a proprietary cloud, a private cloud, a public cloud, and a hybrid cloud.

Further, the terminal device 30 is arranged with an application and a human-computer interaction interface capable of displaying an interface of the application and receiving an operation instruction input by a user. The terminal device 30 is further arranged with an end-side recommendation module arranged for recommendation based on the application. For instance, the end-side recommendation module is implemented with an end-side real-time recommendation model 20 deployed in the terminal device 30. For another instance, a recommendation is made to the terminal device 30 with the deployed end-side recommendation model 20. For still another instance, the end-side recommendation model 20 uses user historical data before each time the terminal device 30 initiates a recommendation request and a real-time interaction behavior of the terminal device 30 in a current page browsing request as feedback to perform fine-grained real-time preference reasoning. Then, at least one recommendation object (such as, a product) which best matches user real-time preference is retrieved, and is presented to a user through the terminal device 30.

The cloud server 10 is arranged with a cloud-side recommendation module and an access module. The cloud server 10 and the terminal device 30 are used as a client and a server of the application, respectively. The cloud server 10 obtains access data (such as, an access log) of the terminal device 10 by means of the access module.

The end-side recommendation module is implemented with a cloud-side real-time recommendation model 110 and a cloud-side time-share recommendation model 120. That is, the cloud-side real-time recommendation model 110 and the cloud-side time-share recommendation model 120 are deployed in the cloud server 10. It should be understood that the cloud-side real-time recommendation model 110, the cloud-side time-share recommendation model 120 and the end-side real-time recommendation model 20 are trained in the cloud server 10, or in a server other than the cloud server 10.

Further, the access data includes historical access data and real-time access data. When a recommendation is made to the terminal device 30 based on the cloud-side real-time recommendation model 110 and the cloud-side time-share recommendation model 120, a recommendation condition input into the cloud-side real-time recommendation model 110 includes historical access data and real-time access data, and the recommendation condition input into the cloud-side time-share recommendation model 120 includes historical access data.

For instance, the cloud-side time-share recommendation model 120 performs preference reasoning with user historical data information before the terminal device 30 initiates a recommendation request to retrieve at least one recommendation object that best matches user preference, and is presented to a user through the terminal device 30. Alternatively, the cloud-side real-time recommendation model 120 performs a recommendation to the terminal device 30. In the terminal device 30, the recommendation result is fed back to the cloud-side real-time model through a communication link each time when one interaction behavior is performed on a recommendation display page of the terminal device 30.

However, the recommendation models in the above embodiments are independently trained and executed in an independent reasoning manner, and there is still room for optimization of a recommendation effect.

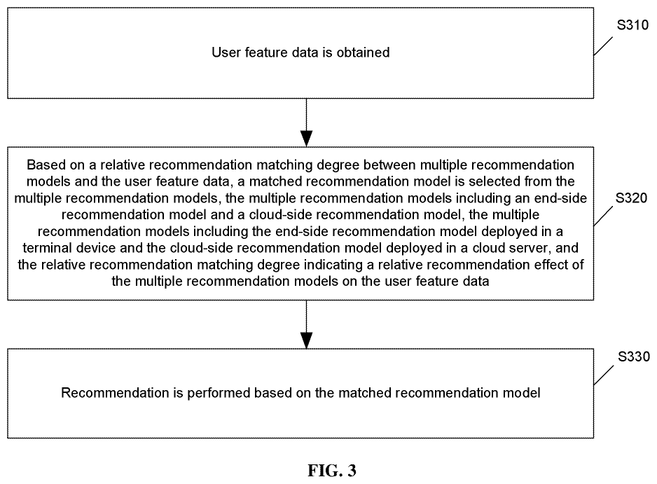

FIG. 2 is a schematic block diagram of a system for edge-cloud collaborative recommendation according to some embodiments of the present disclosure. The system for edge-cloud collaborative recommendation includes a terminal device 210 and a cloud server 220.

It should be understood that both the terminal device 210 and the cloud server 220 are electronic devices capable of data processing. The terminal device 210 includes, but is not limited to, a mobile terminal (such as, a mobile phone, a portable android device (PAD), etc.), a personal computer (PC), etc. The cloud server 220 includes, but is not limited to, a cloud server such as a proprietary cloud, a private cloud, a public cloud, and a hybrid cloud.

The cloud server 220 is arranged for: obtaining user feature data of the terminal device, selecting, based on a relative recommendation matching degree between multiple recommendation models and the user feature data, a matched recommendation model from the multiple recommendation models, and recommending to the terminal device based on the matched recommendation model.

In one instance, an end-side recommendation model is an end-side real-time recommendation model 20 shown in FIG. 1, and a cloud-side recommendation model is a cloud-side real-time recommendation model 110 or a cloud-side time-share recommendation model 120 shown in FIG. 1.

It should be understood that the user feature data includes, but is not limited to, a user identifier, an operation object identifier, an operation state of an operation object, etc. The user feature data includes historical user feature data, or current user feature data (such as, real-time user feature data), or both the historical user feature data and the current user feature data.

In addition, the multiple recommendation models include an end-side recommendation model deployed in the terminal device and a cloud-side recommendation model deployed in the cloud server.

It should be understood that the end-side recommendation model is an end-side real-time recommendation model, the cloud-side recommendation model includes a cloud-side time-share recommendation model and a cloud-side real-time recommendation model, and real-time performance of the cloud-side time-share recommendation model is lower than real-time performance of the cloud-side real-time recommendation model. For instance, the end-side recommendation model, the cloud-side time-share recommendation model and the cloud-side real-time recommendation model are the models shown in FIG. 1, which will not be repeated herein.

It should be understood that, when recommendation is performed on the recommendation model, the recommendation model returns a recommendation result containing at least one recommendation object, and the at least one recommendation object is a recommendation object cut from a candidate recommendation object list and satisfying a recommendation condition.

It should also be understood that the relative recommendation matching degree indicates relative recommendation effects of the multiple recommendation models on the user feature data, and the relative recommendation effects reflect relative recommendation effects of the multiple recommendation models on multiple recommendation results of the user feature data. That is, the better the relative recommendation effect, the higher the relative recommendation matching degree; and the worse the relative recommendation effect, the lower the relative recommendation matching degree. In addition, the relative recommendation effect is obtained based on comparing, by the multiple recommendation models, the multiple recommendation results of the user feature data. That is, the relative recommendation effect is related to the user feature data, different user feature data corresponds to different relative recommendation effects, and the different user feature data corresponds to different matched recommendation models. In addition, the relative recommendation matching degrees are multiple matching degrees of the multiple recommendation models or relations between multiple matching degrees.

It should also be understood that in one instance, multiple recommendation matching degrees of the multiple recommendation models are associated with the user feature data by means of a pre-trained controller. In another instance, relative matching degrees of multiple recommendation matching degrees are associated with the user feature data by means of a pre-trained controller. The controller herein is referred to as a training controller, that is, a classifier model obtained after training a neural network model. Alternatively, the controller is referred to as a meta controller, which is a classification model obtained through thinking training and learning of meta learning. On the basis of that, the controller of the present disclosure is different from a controller as a hardware entity and a controller as a software function configuration, and is a decision model based on a specific algorithm and obtained through training. The controller is flexibly deployed or migrated, or is updated and further trained like other neural network models.

Further, when the controller is pre-trained to associate the relative matching degrees of the multiple recommendation matching degrees with the user feature data, the user feature data is set as the input and the relative matching degree is set as a monitoring label to train the controller created based on a classification neural network. Specifically, the relative matching degree adopts the multiple recommendation models to represent the relative recommendation effects between the multiple recommendation results of the user feature data as the monitoring label. The multiple recommendation models correspond to element values of multiple dimensions of label vectors of monitoring labels. As an instance, for a label vector [0.1; 0.2; 0.3; 0.4], 0.1, 0.2, 0.3 and 0.4 correspond to four recommendation models, respectively, and an absolute value of the element value indicates the relative recommendation effect of each recommendation model. That is, the recommendation effect of the recommendation model corresponding to 0.4 is the best, and the recommendation effect of the recommendation model corresponding to 0.1 is the worst. It should be understood that the element values in the above label vectors are normalized, and non-normalized label vectors may also be used.

More specifically, the label vector is created based on multiple recommendation effect values (for instance, 0.1, 0.2, 0.3 and 0.4 described above) corresponding to the multiple recommendation models one by one. Each element in the label vector is a recommendation effect value.

In the solution of the embodiments of the present disclosure, the recommendation model is selected from the multiple recommendation models including the end-side recommendation model and the cloud-side recommendation model, such that collaboration between the end-side recommendation model and the cloud-side recommendation model can be implemented. In addition, the relative recommendation matching degree indicates the relative recommendation effect of the multiple recommendation models on the user feature data. Therefore, the recommendation model is selected based on the relative recommendation matching degree between the multiple recommendation models and the user feature data, and an applicable recommendation model can be reliably selected. That is, in a case where the end-side recommendation model is applicable, recommendation is performed by the end-side recommendation model, and in a case where the cloud-side recommendation model is applicable, recommendation is performed by the cloud-side recommendation model, such that the recommendation effect can be improved.

In some instances, in order to select the matched recommendation model from the multiple recommendation models based on the user feature data, the user feature data is input into a controller to select the matched recommendation model. In this case, the controller is determined according to a model selection data set, and the model selection data set is created based on training data of the multiple recommendation models.

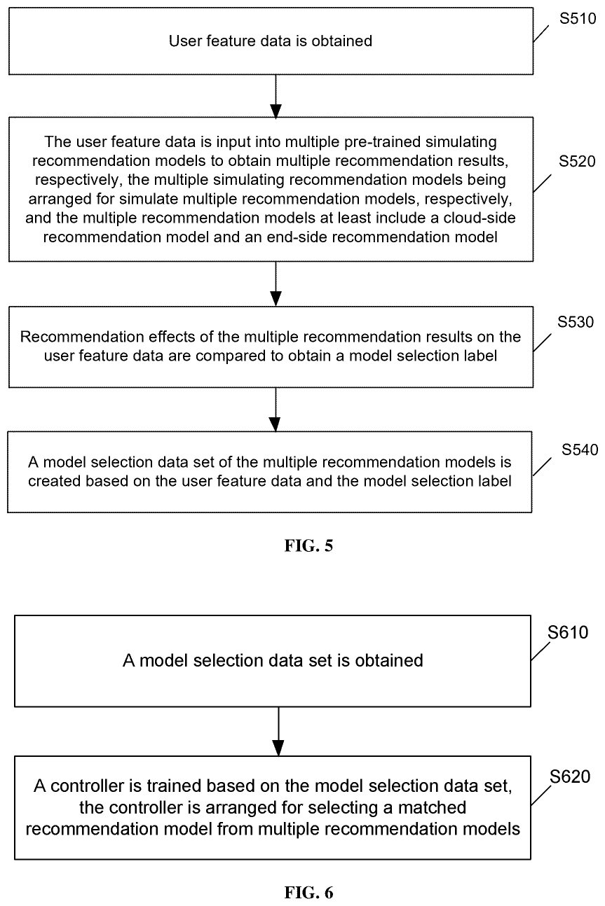

It should be further understood that in a model training stage of the controller, a computing device (such as, a data center) arranged with a central processing unit (CPU) (an instance of a processing unit) and a graphics processing unit (GPU) (an instance of an acceleration unit) is used to train a coder and decoder model based on training samples. The computing device such as the data center is deployed in a cloud server such as a proprietary cloud, a private cloud, or a hybrid cloud. Accordingly, in an inference stage of the controller, the computing device arranged with the CPU (an instance of a processing unit) and the GPU (an instance of an acceleration unit) is used for reasoning operation. Reference may be made to the example corresponding to FIG. 6 for a further training mode of the controller. The recommendation model is efficiently selected by means of the controller. Since the controller is a model, the controller and the multiple recommendation models are deployed in a unified manner.

With the recommendation system in the example of FIG. 1 as an instance, the controller is deployed at the cloud server 10 or the terminal device 30. After the controller determines the matched recommendation model, input data of the matched recommendation model is generated based on the user feature data and input into the recommendation model. For instance, the controller forwards the user feature data to the matched recommendation model.

In some other instances, when recommendation is performed based on the matched recommendation model, the user feature data is input into the matched recommendation model to obtain the recommendation result, such that recommendation efficiency can be improved. For instance, in response to selection of the matched recommendation model, the user feature data is obtained from an input end of the controller. In this case, data of the matched recommendation model is consistent with the input data of the controller, such that a training probability of the controller can be improved.

In some other instances, the user feature data includes user real-time feature data and user historical feature data of an application. Accordingly, when the user feature data is input into the matched recommendation model to obtain the recommendation result, the user real-time feature data and the user historical feature data are input into the end-side recommendation model to obtain a real-time recommendation result of the application. In a case that the end-side recommendation model is deployed at the terminal device, efficiency of obtaining the user real-time feature data can be improved, and further the recommendation effect of the end-side recommendation model can be enhanced.

In some other instances, the user feature data includes the user historical feature data of the application. Accordingly, when the user feature data is input into the matched recommendation model to obtain the recommendation result, the user historical feature data is input into the cloud-side recommendation model to obtain the recommendation result of the application. The cloud-side recommendation model is deployed at the cloud server. Since the cloud server has high computing capability, a cloud-side recommendation model higher in performance can be deployed, such that the recommendation effect of the cloud-side recommendation model can be improved.

Specifically, the cloud-side recommendation model includes a cloud-side time-share recommendation model and a cloud-side real-time recommendation model shown in FIG. 1. For the cloud-side time-share recommendation model, the user historical feature data of the application is obtained from the cloud server so as to perform preference processing, and then, a preference processing result is input into the cloud-side time-share recommendation model to obtain a time-share recommendation result. For the cloud-side real-time recommendation model, the user historical feature data of the application is obtained from the cloud server, and the user real-time feature data is obtained from the controller to perform preference processing. Then, a preference processing result is input into the cloud-side real-time recommendation model to obtain a real-time recommendation result.

Alternatively, for the end-side recommendation model, the user historical feature data of the application is obtained from the cloud server, and the user real-time feature data is obtained from the controller to perform preference processing. Then, a preference processing result is input into the end-side real-time recommendation model to obtain a real-time recommendation result. For instance, in response to selection of the end-side real-time recommendation model, the terminal device obtains the user historical feature data of the application from the cloud server, and obtains the user real-time feature data from the controller.

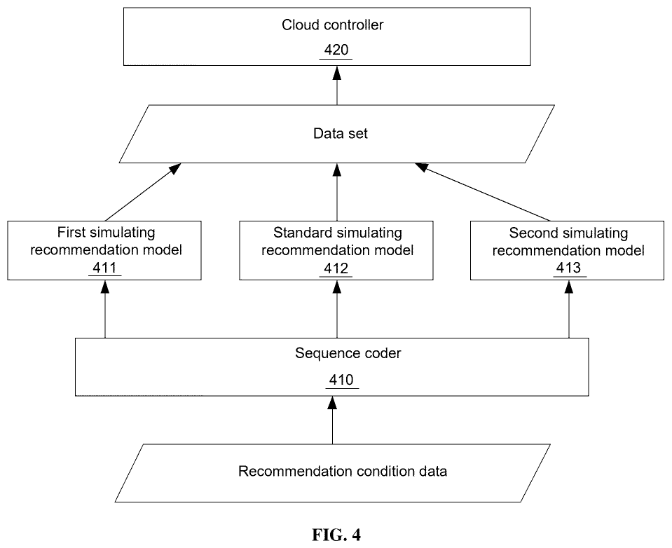

FIG. 3 is a flow diagram of a method for edge-cloud collaborative recommendation according to some embodiments of the present disclosure. This method is applied to any suitable electronic device capable of data processing, and for instance, the cloud server 10 shown in FIG. 1.

The method for collaborative recommendation includes the following steps.

In step S310, user feature data is obtained.

In step S320, based on a relative recommendation matching degree between multiple recommendation models and the user feature data, a matched recommendation model is selected from the multiple recommendation models, the multiple recommendation models including an end-side recommendation model and a cloud-side recommendation model, the multiple recommendation models including the end-side recommendation model deployed in a terminal device and the cloud-side recommendation model deployed in a cloud server, and the relative recommendation matching degree indicating a relative recommendation effect of the multiple recommendation models on the user feature data.

In step S330, recommendation is performed based on the matched recommendation model.

In the solution of the embodiments of the present disclosure, the recommendation model is selected from the multiple recommendation models including the end-side recommendation model and the cloud-side recommendation model, such that collaboration between the end-side recommendation model and the cloud-side recommendation model can be implemented. In addition, the relative recommendation matching degree indicates the relative recommendation effect of the multiple recommendation models on the user feature data. Therefore, the recommendation model is selected based on the relative recommendation matching degree between the multiple recommendation models and the user feature data, and an applicable recommendation model can be reliably selected. That is, in a case where the end-side recommendation model is applicable, recommendation is performed by the end-side recommendation model, and in a case where the cloud-side recommendation model is applicable, recommendation is performed by the cloud-side recommendation model, such that the recommendation effect can be improved.

In some instances, in order to select the matched recommendation model from the multiple recommendation models based on the user feature data, the user feature data is input into a controller to select the matched recommendation model. In this case, the controller is determined according to a model selection data set, and the model selection data set is created based on training data of the multiple recommendation models.

In some other instances, when recommendation is performed based on the matched recommendation model, the user feature data is input into the matched recommendation model to obtain the recommendation result, such that recommendation efficiency can be improved. For instance, in response to selection of the matched recommendation model, the user feature data is obtained from an input end of the controller. In this case, data of the matched recommendation model is consistent with the input data of the controller, such that a training probability of the controller can be improved.

In some other instances, the user feature data includes user real-time feature data and user historical feature data of an application. Accordingly, when the user feature data is input into the matched recommendation model to obtain the recommendation result, the user real-time feature data and the user historical feature data are input into the end-side recommendation model to obtain a real-time recommendation result of the application. In the case that the end-side recommendation model is deployed at the terminal device, efficiency of obtaining the user real-time feature data can be improved, and further the recommendation effect of the end-side recommendation model can be enhanced.

In some other instances, the user feature data includes the user historical feature data of the application. Accordingly, when the user feature data is input into the matched recommendation model to obtain the recommendation result, the user historical feature data is input into the cloud-side recommendation model to obtain the recommendation result of the application. The cloud-side recommendation model is deployed at the cloud server. Since the cloud server has strong computing capability, a cloud-side recommendation model higher in performance can be deployed, such that the recommendation effect of the cloud-side recommendation model can be improved.

Specifically, the cloud-side recommendation model includes a cloud-side time-share recommendation model and a cloud-side real-time recommendation model shown in FIG. 1. For the cloud-side time-share recommendation model, the user historical feature data of the application is obtained from the cloud server to perform preference processing, and then, a preference processing result is input into the cloud-side time-share recommendation model to obtain a time-share recommendation result. For the cloud-side real-time recommendation model, the user historical feature data of the application is obtained from the cloud server, and the user real-time feature data is obtained from the controller to perform preference processing. Then, a preference processing result is input into the cloud-side real-time recommendation model to obtain a real-time recommendation result.

Alternatively, for the end-side recommendation model, the user historical feature data of the application is obtained from the cloud server, and the user real-time feature data is obtained from the controller to perform preference processing. Then, a preference processing result is input into the end-side real-time recommendation model to obtain a real-time recommendation result. For instance, in response to selection of the end-side real-time recommendation model, the terminal device obtains the user historical feature data of the application from the cloud server, and obtains the user real-time feature data from the controller.

FIG. 5 is a flow diagram of a method for creating a data set according to some embodiments of the present disclosure. This method is applied to any suitable electronic device capable of data processing, which includes, but is not limited to, a server, a mobile terminal (for instance, a mobile phone, a PAD, etc.), a PC, etc.

The method for creating a data set includes the following steps.

In step S510: user feature data is obtained.

It should be understood that the user feature data includes, but is not limited to, a user identifier, an operation object identifier, an operation state of an operation object, etc. The user feature data includes historical user feature data, or current user feature data (for instance, real-time user feature data), or both the historical user feature data and the current user feature data.

In step S520: the user feature data is input into multiple pre-trained simulating recommendation models to obtain multiple recommendation results, respectively, the multiple simulating recommendation models being arranged for simulate multiple recommendation models, respectively, and the multiple recommendation models at least include a cloud-side recommendation model and an end-side recommendation model.

It should be understood that the multiple recommendation models include real-time recommendation models and time-share recommendation models. In addition, the real-time recommendation models include a cloud-side real-time recommendation model and an end-side real-time recommendation model.

In step S530: recommendation effects of the multiple recommendation results on the user feature data are compared to obtain a model selection label.

It should be understood that the model selection label indicates a relative recommendation effect between the multiple recommendation results, and the relative recommendation effect reflects superiority and inferiority of the recommendation effect between the multiple recommendation results, so as to reflect recommendation reliability between the multiple recommendation models.

It should be further understood that when the recommendation effects of all the recommendation results are compared, recommendation effects of two recommendation results are compared, or recommendation effects of more than two recommendation results are compared. When the recommendation effects of all the recommendation results are compared, correlations between all the recommendation results and the user feature data are compared, or all the recommendation results are compared.

In step S540: a model selection data set of the multiple recommendation models is created based on the user feature data and the model selection label.

It should be understood that the user feature data and the model selection label are set as input and output of a neural network, respectively, so as to train the recommendation models. The neural network for training is a classifier such as a feed forward neural network and a convolutional neural network.

It should be further understood that although the model selection data set is generated by comparing the recommendation effects of more than two recommendation results, the controller trained based on the model selection data set performs selection on the multiple recommendation models.

In the solution of the embodiments of the present disclosure, the multiple simulating recommendation models are arranged for simulating the multiple recommendation models respectively, so as to provide a consistent user feature data entry, such that the multiple recommendation results can be obtained based on the user feature data, and the model selection label obtained from a comparison result of the multiple recommendation results can reflect differences of the recommendation effects. Therefore, with a data set created based on the model selection label, the multiple recommendation models can be reliably selected, efficient collaboration between the multiple recommendation models can be implemented, and the recommendation effect can be improved.

FIG. 4 is a schematic block diagram of a method for creating a data set according to some embodiments of the present disclosure. As shown in FIG. 4, user feature data is input into a sequence coding layer 410 (for instance, a network layer for embedding processing) to obtain a recommendation condition sequence corresponding to the user feature data. Then, the recommendation condition sequence is input into multiple pre-trained simulating recommendation models. In the instance, the simulating recommendation models include a first simulating recommendation model 411, a second simulating recommendation model 413, and a standard simulating recommendation model 412.

Generally, training data of each recommendation model is obtained, the training data including a recommendation condition and a recommendation result. Then, the multiple simulating recommendation models are trained based on the training data of each recommendation model, respectively. That is, the user feature data is input into the sequence coding layer 410, or the user feature data is not input into the sequence coding layer, and the multiple simulating recommendation models are directly trained based on the training data of each recommendation model, respectively.

In one instance, the first simulating recommendation model 411 is arranged for simulating a cloud-side real-time recommendation model 110, the second simulating recommendation model 413 is arranged for simulating an end-side real-time recommendation model 20, and the standard simulating recommendation model 412 is arranged for simulating a cloud-side time-share recommendation model 120. That is, input training data of the cloud-side real-time recommendation model 110, the end-side real-time recommendation model 20 and the cloud-side time-share recommendation model 120 are the same or not. Input training data of the first simulating recommendation model 411, the second simulating recommendation model 413 and the standard simulating recommendation model 412 are the same. For instance, the same input data sequence of each model recommendation model is obtained through processing of the sequence coding layer 410.

Specifically, a model selection label indicates a relative recommendation effect between a multiple recommendation results, and a model having a better recommendation effect is determined according to the relative recommendation effect. When the recommendation effects of the multiple recommendation results on the user feature data are compared, multiple matching degrees between the multiple recommendation results and the user feature data are determined. In this case, the multiple matching degrees indicate the recommendation effects of the multiple recommendation results, respectively. Then, based on the multiple matching degrees, the model selection label is determined. The higher the matching degree, the better the recommendation effect. It should be understood that the matching degrees may also understood as correlations. The more similar a recommendation object corresponding to the recommendation result is to an operation object in the user feature data, the higher the correlation or matching degree is. For instance, in a product recommendation, if a recommended product belongs to the same category as a product currently clicked on or viewed by a user, a higher correlation or matching degree is indicated.

Alternatively, when the recommendation effects of the multiple recommendation results on the user feature data are compared to obtain the model selection label, respective product popularity of the multiple recommendation results is determined, and then the model selection label is determined based on the respective product popularity of the multiple recommendation results. The higher the product popularity, the better the recommendation effect.

In some instances, the higher the product popularity, the lower the matching degree; and the lower the product popularity, the higher the matching degree. In this case, the recommendation effect of each recommendation result is comprehensively determined based on the product popularity and the matching degree.

Specifically, the model selection label is a vector of multiple dimensions, and all the dimensions indicate recommendation effect values of the multiple recommendation results. The higher the recommendation effect value, the better the relative recommendation effect. For instance, a recommendation vector [0.8; 0.1; 0.1] denotes relative recommendation effects of the recommendation results of the end-side real-time recommendation model, the cloud-side real-time recommendation model and the time-share recommendation model respectively. That is, the end-side real-time recommendation model has an optimal recommendation effect. Therefore, the end-side real-time recommendation model is selected by the controller (such as, a cloud controller) to perform recommendation. It should be understood that in the above instance, each element in the vector is normalized, or each element is not normalized, so as to indicate the relative recommendation effect.

It should be further understood that the dimension of the recommendation vector is smaller than a number of recommendation models. For instance, if the recommendation results of the end-side real-time recommendation model and the cloud-side real-time recommendation model correspond to recommendation vectors of [0.4; 0.6], a recommendation effect value of the cloud-side real-time recommendation model is higher than a recommendation effect value of the end-side real-time recommendation model. In this case, the recommendation vector is equivalent to [0.4; 0.6; 0] of three recommendation models. That is, the time-share recommendation model is not selected, so a recommendation effect value of the time-share recommendation model is 0.

More specifically, a label vector is created based on multiple recommendation effect values corresponding to the multiple recommendation models one by one. Each element in the label vector is a recommendation effect value.

Further, recommendation results of the first simulating recommendation model and the second simulating recommendation model are compared with a recommendation result of a reference simulating recommendation model to obtain a first comparison result and a second comparison result. Then, respective causal gains (such as, at least one of the matching degree and product popularity mentioned above) of the first comparison result and the second comparison result are further compared. More generally, the recommendation results of the multiple simulating recommendation models are compared with the recommendation result of the reference simulating recommendation model to obtain multiple comparison results.

Both the first simulating recommendation model and the second simulating recommendation model are arranged for simulating the real-time recommendation models. Therefore, a selected recommendation model has a better recommendation effect through comparing respective causal gains of the first comparison result and the second comparison result. It should be further understood that multiple recommendation effect values are positively correlated with multiple comparison results respectively, and for instance, the multiple comparison results are determined as the multiple recommendation effect values respectively.

FIG. 6 is a flow diagram of a method for training a model according to some embodiments of the present disclosure. The solution of the embodiments may be applied to any suitable electronic device capable of data processing. The electronic device includes, but is not limited to, a server, a mobile terminal (for instance, a mobile phone, a PAD, etc.), a PC, etc. For instance, in a model training stage, a computing device (for instance, a cloud server 10) arranged with a CPU (an instance of a processing unit) and a GPU (an instance of an acceleration unit) may be arranged for training a coder and decoder model based on training samples. The computing device such as a data center may be deployed in a cloud server such as a proprietary cloud, a private cloud, or a hybrid cloud. Accordingly, in an inference stage, the computing device arranged with the CPU (an instance of a processing unit) and the GPU (an instance of an acceleration unit) may be arranged for reasoning operation.

The method for training a model according to some embodiments includes the following steps.

In step S610, a model selection data set is obtained.

In step S620, a controller is trained based on the model selection data set, the controller is arranged for selecting a matched recommendation model from multiple recommendation models.

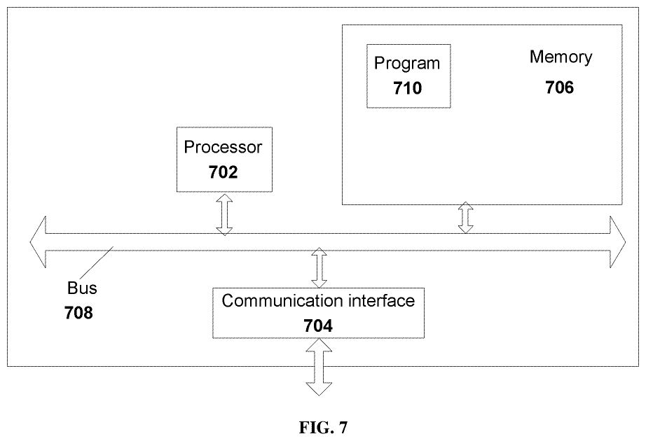

In the solution of the embodiments of the present disclosure, the multiple simulating recommendation models are arranged for simulating the multiple recommendation models respectively, so as to provide a consistent user feature data entry, such that the multiple recommendation results are obtained based on the user feature data, and the model selection label obtained from a comparison result of the multiple recommendation results may reflect differences of the recommendation effects. Therefore, with a data set created based on the model selection label, the multiple recommendation models may be reliably selected, efficient collaboration between the multiple recommendation models can be implemented, and the recommendation effect can be improved. FIG. 7 shows a schematic structural diagram of an electronic device according to some embodiments of the present disclosure. The embodiments of the present disclosure do not limit specific implementation of the electronic device.

As shown in FIG. 7, the electronic device may include: a processor 702, a communication interface 704, a memory 706 storing a program 710, and a communication bus 708.

The processor, the communication interface and the memory are in communication with one another by means of the communication bus.

The communication interface is arranged for communicating with other electronic devices or servers.

The processor is arranged for executing the program, and may specifically execute relevant steps of the above method embodiment.

Specifically, the program may include program codes which include computer operation instructions.

The processor may be a CPU, an application specific integrated circuit (ASIC), or at least one integrated circuit arranged for implementing the embodiments of the present disclosure. At least one processor contained in an intelligent device may be processors of a same type, such as at least one CPU; or may be processors of different types, such as at least one CPU and at least one ASIC.

The memory is arranged for storing the program. The memory may include a high-speed random access memory (RAM), and may also include a non-transitory memory, and for instance, at least one disk memory.

The program is further arranged for enabling the processor to execute the following operations. User feature data is obtained. The user feature data is input into multiple pre-trained simulating recommendation models to obtain multiple recommendation results, respectively, the multiple simulating recommendation models being arranged for simulate multiple recommendation models, respectively. Recommendation effects of the multiple recommendation results on the user feature data are compared to obtain a model selection label. A model selection data set of the multiple recommendation models is created based on the user feature data and the model selection label.

Alternatively, the program is further arranged for enabling the processor to execute the following operations. A model selection data set is obtained. A controller is trained based on the model selection data set, the controller being arranged for selecting a matched recommendation model from multiple recommendation models.

Alternatively, the program is further arranged for enabling the processor to execute the following operations. User feature data is obtained. Based on a relative recommendation matching degree between multiple recommendation models and the user feature data, a matched recommendation model is selected from the multiple recommendation models, the multiple recommendation models including an end-side recommendation model and a cloud-side recommendation model, the multiple recommendation models including the end-side recommendation model deployed in a terminal device and the cloud-side recommendation model deployed in a cloud server, and the relative recommendation matching degree indicating a relative recommendation effect of the multiple recommendation models on the user feature data; and a recommendation condition is recommended based on the matched recommendation model to obtain a recommendation result.

In addition, reference may be made to corresponding description of corresponding steps and units in the above method embodiments for specific implementation of each step in the program, which is not repeated herein. Those skilled in the art may clearly understand that, for convenience and conciseness of description, reference may be made to corresponding process description in the above method embodiments for a specific work process of the device and module described above, which will not be repeated herein.

It should be noted that, according to needs of implementation, each component/step described in the embodiments of the present disclosure may be split into more components/steps, or two or more components/steps or components/some operations of steps may be combined into new components/steps, so as to achieve the objective of the embodiments of the present disclosure.

The method according to the embodiments of the present disclosure may be implemented in hardware or firmware, or implemented as software or a computer code that may be stored in recording media (such as a compact disc read-only memory (CD ROM), a RAM, a floppy disk, a hard disk, or a magneto-optical disk), or implemented as a computer code downloaded through a network, which is originally stored in a remote recording medium or a non-temporary machine-readable medium and is to be stored in a local recording medium, such that the method described herein may be stored in such software processing on a recording medium using a general-purpose computer, a special-purpose processor, or programmable or special-purpose hardware (such as an ASIC or a field-programmable gate array (FPGA)). It may be understood that a computer, a processor, a microprocessor controller or programmable hardware includes a storage component (for instance, a RAM, a ROM, a flash memory, etc.) that may store or receive software or computer codes, and when the software or computer codes is accessed and executed by the computer, the processor or the hardware, the method shown herein is implemented. Further, when a general-purpose computer accesses codes used for implementing the method shown herein, execution of the codes converts the general-purpose computer into a special-purpose computer arranged for executing the method shown herein.

Those of ordinary skill in the art may understand that units and method steps of the instances described in connection with the embodiments disclosed herein may be implemented in electronic hardware, or a combination of computer software and electronic hardware. Whether the functions are executed in hardware or software depends on specific application and design constraints of the technical solution. Professionals may use different methods to implement the described functions for each specific application, but such implementation should not be considered to fall beyond the scope of the embodiments of the present disclosure.

The above embodiments are used for illustrating the embodiments of the present disclosure, instead of limiting the embodiments of the present disclosure. Those of ordinary skill in the relevant technical fields may make various changes and modifications without departing from the spirit and scope of the embodiments of the present disclosure. Therefore, all equivalent technical solutions also belong to the scope of the embodiments of the present disclosure, and the patent protection scope of the embodiments of the present disclosure should be limited by the claims.

1. A system for edge-cloud collaborative recommendation, comprising: a terminal device and a cloud server, wherein the cloud server is arranged for:
obtaining user feature data of the terminal device;
selecting, based on a relative recommendation matching degree between a plurality of
recommendation models and the user feature data, a matched recommendation model from the plurality of recommendation models, the plurality of recommendation models comprising an end-side recommendation model deployed in the terminal device and a cloud-side recommendation model deployed in the cloud server, and the relative recommendation matching degree indicating a relative recommendation effect of the plurality of recommendation models on the user feature data; and
recommending to the terminal device based on the matched recommendation model.

2. The system as claimed in claim 1, wherein the cloud server is further arranged for: inputting the user feature data into a controller to select the matched recommendation model, wherein the controller is determined according to a model selection data set, and the model selection data set is created based on training data of the plurality of recommendation models.

3. The system as claimed in claim 1, wherein the cloud server is further arranged for: inputting the user feature data into the matched recommendation model to obtain a recommendation result.

4. The system as claimed in claim 1, wherein the user feature data comprises user real-time feature data and user historical feature data of an application, and
the cloud server is further arranged for: inputting the user real-time feature data and the user historical feature data into the end-side recommendation model to obtain a real-time recommendation result of the application.

5. The system as claimed in claim 1, wherein the user feature data comprises user historical feature data of an application, and the cloud server is further arranged for:
inputting the user historical feature data into the cloud-side recommendation model to obtain a recommendation result of the application.

6. A method for creating a data set, comprising:
obtaining user feature data;
inputting the user feature data into a plurality of pre-trained simulating recommendation models to obtain a plurality of recommendation results, respectively, the plurality of simulating recommendation models being arranged for simulating a plurality of recommendation models, respectively, and the plurality of recommendation models at least comprising a cloud-side recommendation model and an end-side recommendation model;
comparing recommendation effects of the plurality of recommendation results on the user feature data to obtain a model selection label; and
creating a model selection data set of the plurality of recommendation models based on the user feature data and the model selection label.

7. The method as claimed in claim 6, wherein inputting the user feature data into the plurality of pre-trained simulating recommendation models comprises:
inputting the user feature data into a sequence coding layer to obtain a recommendation condition sequence corresponding to the user feature data; and
inputting the recommendation condition sequence into the plurality of pre-trained simulating recommendation models.

8. The method as claimed in claim 6, further comprising:
obtaining training data of each recommendation model, wherein the training data comprises a recommendation condition and a recommendation result; and
training the plurality of simulating recommendation models based on the training data of each recommendation model, respectively.

9. The method as claimed in claim 6, wherein comparing the recommendation effects of the plurality of recommendation results on the user feature data to obtain the model selection label comprises:
determining a plurality of matching degrees between the plurality of recommendation results and the user feature data, the plurality of matching degrees indicating the recommendation effects of the plurality of recommendation results, respectively; and
determining the model selection label based on the plurality of matching degrees, the model selection label indicating a relative recommendation effect between the plurality of recommendation results.

10. (canceled)

11. A method for edge-cloud collaborative recommendation, comprising:
obtaining user feature data;
selecting, based on a relative recommendation matching degree between a plurality of recommendation models and the user feature data, a matched recommendation model from the plurality of recommendation models, the plurality of recommendation models comprising the end-side recommendation model deployed in a terminal device and the cloud-side recommendation model deployed in a cloud server, and the relative recommendation matching degree indicating a relative recommendation effect of the plurality of recommendation models on the user feature data; and
performing recommendation based on the matched recommendation model.

12. (canceled)

13. The system as claimed in claim 1, wherein the end-side recommendation model is an end-side real-time recommendation model, the cloud-side recommendation model includes a cloud-side time-share recommendation model and a cloud-side real-time recommendation model, and real-time performance of the cloud-side time-share recommendation model is lower than real-time performance of the cloud-side real-time recommendation model.

14. The system as claimed in claim 1, wherein the recommendation model returns a recommendation result containing at least one recommendation object.

15. The system as claimed in claim 14, wherein the at least one recommendation object is a recommendation object cut from a candidate recommendation object list and satisfying a recommendation condition.

16. The system as claimed in claim 1, wherein the relative recommendation effect is obtained based on comparing, by the plurality of recommendation models, the plurality of recommendation results of the user feature data.

17. The system as claimed in claim 1, wherein the relative recommendation matching degrees are the plurality of matching degrees of the plurality of recommendation models or relations between the plurality of matching degrees.

18. The method as claimed in claim 11, wherein the end-side recommendation model is an end-side real-time recommendation model, the cloud-side recommendation model comprises a cloud-side time-share recommendation model and a cloud-side real-time recommendation model, and real-time performance of the cloud-side time-share recommendation model is lower than real-time performance of the cloud-side real-time recommendation model.

19. The method as claimed in claim 18, wherein the user feature data comprise: user historical feature data, the method further comprises:
for the cloud-side time-share recommendation model, obtaining the user historical feature data of the application from the cloud server to perform preference processing to obtain a preference processing result;
inputting the preference processing result into the cloud-side time-share recommendation model to obtain a time-share recommendation result.

20. The method as claimed in claim 18, wherein the user feature data comprise: user historical feature data and user real-time feature data, the method further comprises:
for the cloud-side real-time recommendation model, obtaining the user historical feature data of the application from the cloud server, and obtaining the user real-time feature data from a controller to perform preference processing to obtain a preference processing result;
inputting the preference processing result into the cloud-side real-time recommendation model to obtain a real-time recommendation result.

21. The method as claimed in claim 18, wherein the user feature data comprise: user historical feature data and user real-time feature data, the method further comprises:
for the end-side recommendation model, obtaining the user historical feature data of the application from the cloud server, and obtaining the user real-time feature data from a controller to perform preference processing to obtain a preference processing result;
inputting the preference processing result into the end-side real-time recommendation model to obtain a real-time recommendation result.

22. The method as claimed in claim 6, wherein the model selection label indicates a relative recommendation effect between the plurality of recommendation results, the relative recommendation effect reflecting superiority and inferiority of each recommendation effect between the plurality of recommendation results.
